(19) United States
(12) Patent Application Publication
(10) Pub. No.: US 2007/0281742 A1
(43) Pub. Date: Dec. 6, 2007

(54) METHOD AND APPARATUS FOR FACILITATING DISCRETIONARY CONTROL OF A USER INTERFACE

(76) Inventors: Hoi L. Young, Lake Villa, IL (US); Michael Bohan, Fox Lake, IL (US); Christopher W. Drackett, Chicago, IL (US); Thomas C. Hill, Crystal Lake, IL (US); Steven J. Nowlan, South Barrington, IL (US); Conor P. O'Sullivan, Chicago, IL (US); Chad A. Phipps, Grayslake, IL (US); Maria B. Thompson, Hoffman Estates, IL (US); Elisa S. Vargas, Chicago, IL (US); Theodore R. Arneson, Ivanhoe, IL (US)

Correspondence Address: SoCAL IP LAW GROUP LLP, 310 N. WESTLAKE BLVD. STE 120, WESTLAKE VILLAGE, CA, 91362, US

(21) Appl. No.: 11/421,137

(22) Filed: May 31, 2006

(51) Int. Cl. H04B 1/38; H04M 1/00

(52) U.S. Cl. 455/557

(57) ABSTRACT

A device (300) having a user interface (303) is provided with an automatic discretionary capability of determining use of a wireless message. The wireless message may contain user interface preference information that is initially sourced by an end user platform. The device uses the automatic discretionary capability to determine whether and to what extent to use the user interface preference information to influence control of the user interface (303). The device (300) may contain a wireless receiver (302) for receiving the wireless messages with a memory (304) for storing the user interface preference information therein. Also provided in the device (300) is a processor (301) which provides and uses the automatic discretionary capability to determine to what extent to use the user interface preference information to influence control of the user interface (303). The automatic discretionary capability of the device (300) may override, accept, or weight the user interface preference information.

### TECHNICAL FIELD

This invention relates generally to a user interface and discretionary control thereof.

### BACKGROUND

Various devices with user interfaces are known in the art. These devices may include landline telephones, cellphones, pagers, radios, televisions, computers, and many other similar devices. These devices typically render content or give a response to input entered by a user into a user interface, such as a visual response (i.e. turning on a television, or adjusting the brightness of lights) or an audible response (i.e. adjusting the volume of a radio or television, or turning a ringer volume on or off for a telephone or cellphone).

These devices having user interfaces often have many preference settings such as power on or off, a range of volume settings, incoming call annunciation choices such as vibration or ring, just to name a few. Unfortunately for the user, each such device typically requires individual interaction in order to establish these preference settings. The user most often has to physically interact with the user interface of each individual device to enact their preferred settings. For example, if a user wishes for all audible content devices to have a low or softer volume setting, each device must be individually adjusted by the user. Not only does this become an annoyance to the user, but each device may be logistically different. For example, each user interface may present a uniquely different way to achieve the preference setting, thus forcing the user to learn many user interfaces in order to be able to effect the same setting on each device.

Previously, universal remote control devices have attempted to resolve these issues by facilitating control of multiple devices through use of one device (the universal remote control). The universal remote control device only requires the user to interact with a single user interface, that of the universal remote control device itself. The universal remote control device itself, however, often requires specific knowledge of the devices to be controlled. For example, the universal remote control device often needs to be specifically programmed to control a given television, stereo, light system, and digital video disc player. This frequent requirement that the universal remote control device have such information can itself present a significant obstacle to ease of usage.

Furthermore, such a universal remote control device does not typically have the ability to effectively simultaneously control multiple devices nor does it typically have the ability to specify a specific setting for a plurality of devices (i.e. typical universal remote controls cannot set a specific volume level to be applied to all of the devices). Also, as a result of new and/or constantly changing protocols and technologies, such universal remote controls can quickly become obsolete if a new device cannot be programmed into the remote. Such a universal remote control also, of course, consists of yet another item that the user must carry in order to control these multiple devices and that requirement is objectionable to many potential users.

### BRIEF DESCRIPTION OF THE DRAWINGS

The above needs are at least partially met through provision of the method and apparatus for discretionary control of a user interface described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention; and

FIG. 3 comprises a block diagram as configured in accordance with various embodiments of the invention.

Skilled artisans will appreciate that common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a device having a user interface is provided with an automatic discretionary capability of determining use of a wireless message. The wireless message may contain user interface preference information that is initially sourced by an end user platform. The device uses this discretionary capability to determine whether to use, and to what extent to use, the user interface preference information to influence control of the user interface. The device may also contain a wireless receiver for receiving the wireless messages with a memory for storing the user interface preference information therein. Also provided in the device is a processor which provides and uses the discretionary capability to determine to what extent to use the user interface preference information to influence control of the user interface.

The discretionary capability of the device may override, accept, or weight the user interface preference information as may be desired. Weighting at least some of the user interface preference information can comprise providing weighting factors as a function of at least one predetermined factor. Additionally, the device may be capable of receiving a plurality of wireless messages containing user interface preference information initially sourced from a plurality of end user platforms. The device may further determine to what extent to use the plurality of user interface preference information as a function of a majority-based view.

The method disclosed herein may implement preferences registered on one platform in other platforms. For example, if a low volume level is preferred, only one device, the end user platform, needs to be set at that preference setting. That preference setting can then be transmitted to other platforms via a wireless message that is sent from the end user platform to a second platform. Furthermore, the end user platform is not a remote control device and it too may also receive transmissions of preference settings from other platforms. The platform receiving the transmission may decide whether or not to observe the preference setting received in the transmission and to what extent to observe it. The receiving platform may receive messages from single or multiple users.

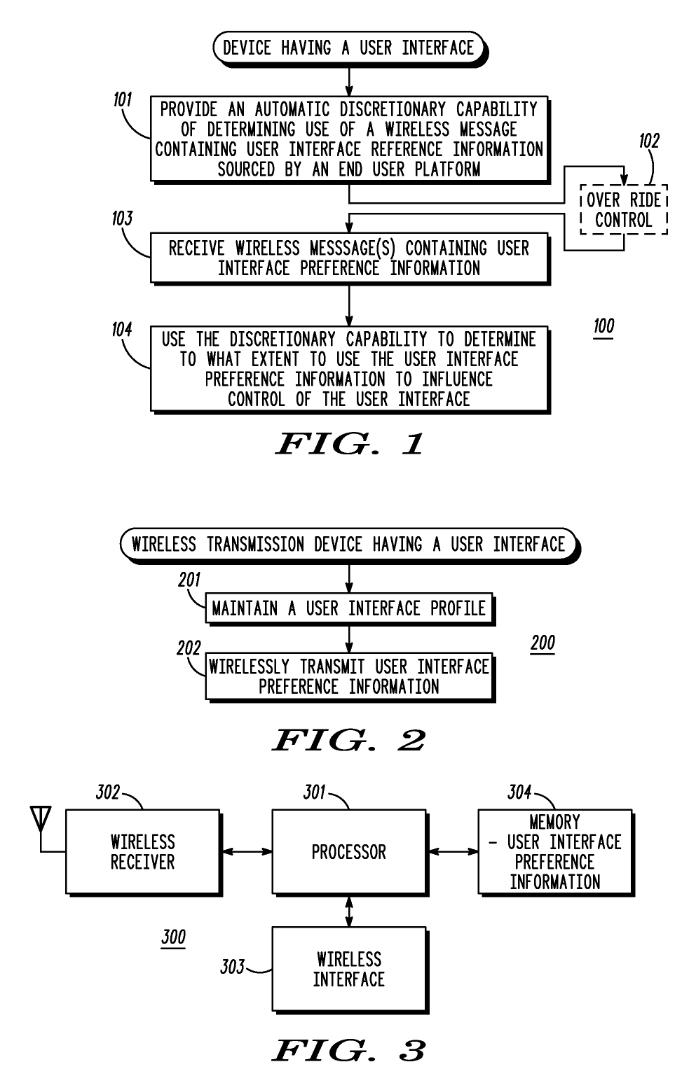

These and other benefits may become clearer upon making a thorough review and study of the following detailed description. Referring now to the drawings, and in particular to FIG. 1, a flow diagram 100 is presented that depicts the method of use for a receiving device having a user interface that has an automatic discretionary capability to determine whether and to what extent to use the user interface preference information received in a wireless message to influence control over its user interface. More particularly, as depicted at step 101, the device has an automatic discretionary capability of determining whether to use, and to what extent to use, a wireless message containing user interface preference information as was initially sourced by an end user platform. The device having a user interface may be any of a number of devices with user interfaces and capable of receiving wireless messages, such as, for example, a cellphone, a television, a radio, a light, a computer, a temperature controller, an answering machine, a car stereo, or any other such device that it may be desirable to control. An end user platform that is the source of the wireless message may comprise any number of devices capable of transmitting wireless messages similar to the devices listed previously for the receiving device and may be a similar or a different device as the receiving device. A wireless message may be a message that originated as a wireless transmission regardless of the form in which it may be received (i.e., whether received as a wired message or a wireless message). For example, a wireless message may originate as a wireless transmission received wirelessly by a receiver which may then further transmit the signal in a wired manner to a second receiver within the wireless system.

By one approach the wireless message that is sent by the end user platform contains user interface preference information exhibiting a preference or setting of the end user platform and requesting to influence control over the user interface of the receiving device. The wireless message is a transmission sent from the end user platform to another device and/or vice versa. These wireless messages contain user interface preference information that contain the user's preferences relating to the user interface of their device which can be shared with other devices having similar user interface capabilities. For example, the user interface preference information may indicate a volume control level, such as a loud or high setting or 80% volume setting. This volume preference level may then be passed onto other devices that also have volume controls. Typically the user would have to manually adjust the volume on each device individually, but by transmitting the wireless message with the user interface preference information, all devices receiving the wireless message can automatically adjust their volume accordingly without any further adjustment from the user. Examples of various other user interface preference information commands may be ringer on/off, ringer volume, ringer type (i.e. vibrate), electronic equipment volume control, device on/off, displayed text characteristics (such as font, font size, color, and so forth), temperature settings for various rooms, lighting brightness settings for rooms, seat position preference in a car, and the like.

Alternatively, the automatic discretionary capability may be capable of determining to use, and to what extent to use, a plurality of wireless messages, each containing user interface preference information received from a plurality of end user platforms. This may be described as many devices with similar and/or the same preferences transmitting wireless messages to define the preferences and/or settings for another device. Each of the plurality of devices (i.e. end user platforms) may all be transmitting user interface preference information for the same user interface setting (i.e. all transmitting a volume level preference) or they may be transmitting different user interface preferences for control of a similar setting to the same device (i.e. one device transmits a volume level, another device transmits a ringer type, and a third device transmits ringer on/off).

The device further uses the discretionary capability, at step 104, to determine to what extent to use the user interface preference information to influence control of the user interface of the receiving device. The discretionary capability may respond to the user interface preference information by overriding, accepting, or weighting the user interface preference information received, or any combination thereof. For example, the receiving device may override the user interface preference information by determining not to accept the user interface preference information and overriding it with other user interface preference information, such as its own user interface preference information or another user interface preference information message received from another device. For example, if the wireless message contains user interface preference information instructing a cellphone, as the receiving device, to lower its volume, the discretionary capability of the cellphone may determine that its own user interface preference information overrides the user interface preference information of the transmitting device and may reject this effort of controlling its user interface, thus leaving its volume as is, without adjusting it per the wireless message.

Another approach may be for the device to confirm reception of the user interface preference information and to accept control of its user interface. In that case, if the user interface preference information of the wireless message indicates to lower the volume of the receiving device, in this example a cellphone, the discretionary capability may decide to confirm the user interface preference information and to accept it, thus allowing the cellphone volume to be lowered to the indicated level in the wireless message.

One approach involves using the discretionary capability to weight at least some of the user interface preference information that is received against one or more weighting factors stored within the receiving device. The weighting factors are a function of at least one predetermined factor that may be preset by the user. One of the predetermined factors may be the proximity of the receiving device to another object. The proximity factor is such that the receiving device will make a determination of how to respond to a received message based on how close or how far away the transmitting device is from the receiving device. For example, if the device receives a temperature setting as the user interface preference information and the discretionary capability uses a weighting factor of proximity, when the transmitting device is far away from the device (a distance that is predetermined by the proximity setting) the device may not accept the message; when the transmitting device is close (a distance that is predetermined by the proximity setting) the device can accept the message. Another predetermined factor may be local loudness, which compares the user interface preference information received to the ambient noise level, where the ambient noise level may be loud, soft, or any other typical volume setting. For example, if a receiving device receives a message to adjust its volume to a low setting, but the loudness level of its surroundings is high in comparison, the device may determine to ignore and/or override the message, or to make a compromise by adjusting its volume to some intermediate level between low and where it currently is set. Other similar factors are local brightness (for light settings) and local temperature. By one approach, these weighting factors can serve to effectively prioritize the corresponding instruction or control request to thereby permit the receiving device to make a more nuanced decision regarding whether, or to what extent, the instruction or control request is to be observed.

Still other weighting factors may be majority rules, house rules, and/or historical factors. The majority rule factor can comprise receiving the user interface preference information and weighing it against a majority of user interface preference information for the same user interface control setting as has been received from other users (and/or other user devices). In that case, the user interface preference information could be accepted if it related to the majority of the wireless messages, and rejected if it did not. This weighting factor is similar to the majority-based view, to be discussed later. The house rule factor can comprise a central platform or network manager that has control over its user interface. The house rule may override all other user interface preference information that it may receive in its locality or it may accept user interface preference information up to a certain limit, where thereafter it overrides the user interface preference information, or even still it may effect a compromise between its preference setting and the user interface preference information received by adjusting the setting, but to an intermediate level. For example, if the house location is a sports bar with multiple televisions set to various sports channels, the house rule may restrict changing the channels of the televisions during a certain time, for example during the dinner rush hour (i.e. from 5 pm to 8 pm) and allow it to be changed during other times, or, alternatively the house rule may limit the channels that a television may be changed to during the dinner rush hour and thus would use its discretionary capability to weight the user interface preference information received against the weighting factors of the house rules, which is limited to certain channels only at a certain time, for example.

Lastly, historical factors can comprise receiving the user interface preference information and comparing it to that device's (or that user's) history of previous user interface preference information. This factor could therefore be a learned function of prior usage. For example, a certain device may have a history of sending a wireless message with user interface preference information to adjust a volume level high and then after a short time send another wireless message to adjust the volume level low. The discretionary capability of the device may take the history of the prior usage into account and decide to only adjust the volume level to some intermediate setting, such as volume level medium, based on what it has learned in the past for this particular transmitting device. Similarly, a device may transmit a channel setting on a television that is typically followed by a volume level adjustment. This historical factor may then take the learned prior usage and also adjust the volume setting after the channel preference is received without waiting for a second message with the volume setting to be sent and received.

One approach involves using the discretionary capability to determine to what extent to use the user interface preference information to influence control of the receiving device's user interface as a function, at least in part, of a majority-based view of multiple user interface preference information that is received. For instance, a plurality of transmitting devices may be sending a plurality of wireless messages to a unitary receiving device. These wireless messages may contain user interface preference information for the same user interface setting of the receiving device or some messages may indicate one setting such as volume high and other devices may indicate a second setting such as volume low and still other devices may contain a third setting such as volume off. The discretionary capability of the receiving device determines what setting the majority of wireless messages are transmitting and will decide to respond (by overriding, accepting, or weighting) to that user interface preference information of the majority.

This is another example of many devices transmitting to one device. This can be shown by a plurality of cellphone devices transmitting user interface preference information from their user interface to a receiving device, where the receiving device is a home stereo and the user interface preference information indicates a volume setting. The discretionary capability of the home stereo would then determine which user interface preference information setting is part of the majority of wireless messages and then respond to that user interface preference information setting over the other plurality of user interface preference information settings that are in the minority. In responding to the majority-based user interface preference information, the discretionary capability may still be used to apply its own user interface preference information setting to override the majority, accept the majority-based setting, or weight the majority-based user interface preference information setting against its own user interface weighting factors.

An optional step between 101 and 104 is that of receiving wireless messages that contain the user interface preference information, shown at step 103. The device may receive a plurality of wireless messages each containing user interface preference information that was initially sourced by a corresponding plurality of end user platforms, or may receive a single wireless message as initially sourced from a single end user platform. The former situation is an example of many transmitting devices each transmitting at least one wireless message to the receiving device. Both scenarios (plurality of messages/platforms and a single message/platform) may also be illustrated as one device to one device to many devices (one-to-one-to-many). This is where one user may define a specific preference and/or setting for one device and thereafter, that one device may define the same preference and/or setting to other devices with similar preference and/or setting capabilities. In this case, the device transmitting the wireless message to the (final) receiving device is not the source of the wireless message containing the user interface preference information, but rather an intermediate receiving device that also has the capability to pass on the user interface preference information by transmitting it to another receiving device. The intermediate receiving device may have received the initial wireless message from the transmitting device (i.e. end user platform) or from yet another intermediate receiving device that in turn received the wireless message from either the end user platform or from another intermediate receiving device. There may be any number of intermediate receiving devices in a series between the end user platform and the final receiving device that transmit the initial wireless message as sourced by the end user platform. An example may be of a volume setting transmitted from the end user platform to a cellphone, then from the cellphone to a residential telephone, then to a television, to a stereo, and ending with a final transmission to a car stereo.

The latter situation depicts one transmitting device (end user platform) transmitting to one receiving device (one-to-one), or, alternatively it may also illustrate one-to-many in the sense of one transmitting device sending a plurality of wireless messages to a plurality of receiving devices where each receiving device receives a single wireless message transmission from the end user platform, thus resembling a one-to-one transmission as between the single receiving device and the end user platform. This allows one user to define the various preferences and/or settings for many different devices. This may also further be depicted by a plurality of transmitting devices (or end user platforms) transmitting a plurality of wireless messages to a plurality of receiving devices (i.e., many-to-many). This is where many users with similar and/or same preferences and settings define various preferences and/or settings for many other devices. When this many-to-many transmission is further broken down and a single transmission is isolated, it resembles the one-to-one transmission already discussed above; basically this becomes a plurality of one-to-one transmissions.

Turning to the flow diagram 200 depicted in FIG. 2, a wireless transmission device is shown having a user interface that maintains a user interface profile that contains the user interface preference information, as shown at step 201. The user interface preference information is then wirelessly transmitted, at step 202, to the receiving device having a user interface, as in FIG. 1, and this wireless message transmission is received at step 103.

Those skilled in the art will appreciate that the above-described processes are readily enabled using any of a wide variety of available and/or readily configured platforms, including partially or wholly programmable platforms as are known in the art or dedicated purpose platforms as may be desired for some applications.

Those skilled in the art will also recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art. The block diagram in FIG. 3 depicts an apparatus 300 for receiving and responding to the wireless messages received, as shown by the method in FIG. 1. The apparatus 300 comprises a wireless receiver 302, a memory 304, a processor 301, and a user interface 303. The apparatus 300 may have a wireless receiver 302 that receives user interface preference information contained in a wireless message as was initially sourced by an end user platform. The wireless receiver 302 may also receive a plurality of wireless messages where each message may contain user interface preference information as was initially sourced by a corresponding plurality of end user platforms. The wireless receiver 302 could also be wired to another receiver, for example, within a wireless system, such that initially it receives a wireless message and then transmits the message in a wired manner to the final receiver.

The wireless receiver 302 is operably coupled to the memory 304, which stores the user interface preference information received by the wireless receiver 302. There is also a processor 301 which is operably coupled to the memory 304 and the user interface 303, and where the processor 301 provides to the apparatus 300 an automatic discretionary capability of determining whether to use, and to what extent to use, the user interface preference information stored in the memory 304. The processor 301 is also capable of using its automatic discretionary capability to determine to what extent to use the user interface preference information to influence control of the user interface 303. The processor 301 is further capable of using its automatic discretionary capability to determine whether to use, and to what extent to use, a plurality of wireless messages each containing user interface preference information as was initially sourced by a corresponding plurality of end user platforms. The processor 301 uses its discretionary capability to respond to the wireless message(s) in a similar fashion as previously discussed (override, confirm, weighting, or majority-based view responses). This platform can be used to effect the previously disclosed processes which include, for example, the aforementioned automatic discretionary capability.

By one approach one may accommodate a plurality of such devices. A desired volume level for an audible annunciation mechanism is selected and transmitted via an audible annunciation mechanism control signal to a plurality of two-way communications devices. The audible annunciation mechanism control signal may be transmitted by a network manager or some other central locality that acts as a manager. The plurality of two-way communications devices then receive the audible annunciation mechanism control signal and use the desired volume level to control the local audible annunciation mechanism of the two-way device.

Additionally, the local audible annunciation mechanism may have an automatic discretionary capability of determining whether to use, and to what extent to use, the audible annunciation mechanism control signal and then using this discretionary capability to determine to what extent to use the audible annunciation mechanism control signal to influence control of the local audible annunciation mechanism. The audible annunciation mechanism control signal may be a desired volume level or an on/off condition that is transmitted to the two-way communications devices, where the devices may also have a user interface.

The devices may also have a setting that simply overrides any control signal sent to it, as illustrated at step 102. This may be the case, for example, where the devices are cellphones or pagers that receive a control signal to mute or turn off the ringer volume and where the cellphone or pager is set up to override, and thus reject, any such commands. This may be desirable in the case where a physician or on-call doctor needs to be able to be reached at all times and cannot risk missing a call because their receiving device was muted or turned off without them knowing or intending for that condition to occur.

As used herein, two-way communications devices include, but are not limited to, cellphones, pagers, personal digital assistants (PDAs), two-way communications devices including push-to-talk platforms, and the like. An audible annunciation mechanism may be a ringer of a cellphone or pager, an audible alarm setting on a PDA or cellphone, and the like. Volume levels may control volume levels for a ringer mechanism, for an alarm, or any other type of audible response. For example, a volume level for a ringer mechanism may include not only level adjustments to loudness or softness, but also may include a vibration mode of the ringer, a silent mode, or turning the ringer off or on. Any other number of ringer control options may also be included besides the few listed above.

A central locality or a network manager may select the desired volume level or designation, such as ringer mode set to vibrate, and transmit it as an audible annunciation control signal to all the cellphones, for example, within its locality or within its control. The network manager may be, for instance, a user that may wish to control the volume level or designation of devices at its location by setting the two-way communications devices to a different setting than they are already set to. A movie theater, a hospital, a concert hall, a library, or other similar venues may wish to keep the volume level low or off on cellphones or other similar devices within their control. Conversely, places such as train stations, cafeterias, city sidewalks, or other similar venues that are typically very loud may wish to adjust the volume of their customer's cellphone ringers, or other similar devices, louder so that they may be heard over the background noise.

Therefore, whenever the two-way communications devices are brought into this predefined locality controlled by a network manager, a control signal is sent out to all devices within its reach with a request that the devices respond to its control signal. An example of the method of this further embodiment is one where the two-way communications devices may be cellphones and the audible annunciation mechanism may be the cellphone ringer. When the user of the cellphone is within an area that is controlled by a network manager, such as a movie theater, the network manager may send a wireless message to the cellphone with the user interface preference information to turn off the ringer or turn it to vibrate, for example. The cellphone's user interface may also contain a discretionary capability to respond to the network manager's signal and may either override, accept, or weight the command, as previously discussed. In this manner, a movie theater network manager can reach multiple customers in the theater and ensure that their phones are indeed turned off. The network manager may allow various urgent status cellphones (i.e. a physician's phone) to apply its discretionary capability to maintain its current settings or to make a compromise.

A preference setting at one platform may be transmitted to one or more platforms. As discussed, a volume level preference that is specified at one device, such as the end user platform, can then be transmitted to other platforms via a wireless message that is sent from the end user platform to the second platform. The receiving platform has the capability to decide whether or not to observe the preference setting received in the transmission and to what extent to observe it.

In some instances, the preference message may contain additional contextual information which can impact how a preference is prioritized. A particular instance is the transfer of an in process cellphone call between devices. Wireless car kits now exist which will permit a cellphone call to be automatically transferred from the audio system of the cellphone to the audio system of a vehicle without interrupting the call. In instances such as this it is desirable that any adjustments made to, for example, volume control specific to that call should be transmitted as a special high priority preference for the continuation of the same call, which would override any regular preferences for volume. This type of current context specific adjustment is accommodated in the current invention.

As discussed herein, a user only needs to set one device that they are already using to the user's preferences and that device can transmit these preferences to other devices that the user may also wish to control for a seamless, enjoyable experience to the user. There is no need for the user to individually and manually adjust each device for which the user wishes to effect the same setting. Additionally, the receiving device that receives the sourced information from the user's device can either accept the setting or decide whether or not to use it, thus exhibiting a discretionary capability on the part of the receiving device.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one example, the power reserves of the receiving device may be taken into account as a basis for exercising the aforementioned discretionary capability. To illustrate, a device that receives a message indicating a preference for higher audio volume but that has relatively low power reserves (in the form, for example, of a nearly exhausted battery) may exercise its discretionary capability to not increase its present volume or to only increase the volume by a more modest amount in order to better husband its present power reserves. As another example, the discretionary capability can be exercised on a relatively dynamic basis to permit case-by-case decisions to be made. To illustrate, a given two-way communications device may have received, and observed, a received preference regarding lower incoming-call ringer volumes. Upon receiving, however, an incoming call that bears a high priority indicator, this device might nevertheless elect to partially or wholly override this previous observance regarding volume in favor of rendering a relatively loud ringer to announce the higher priority incoming call.

We claim:

1. A method comprising:
at a device having a user interface:
providing the device with an automatic discretionary capability of determining whether to use, and to what extent to use, a wireless message containing user interface preference information as was initially sourced by an end user platform;
using the automatic discretionary capability to determine to what extent to use the user interface preference information to influence control of the user interface.

2. The method of claim 1 wherein using the automatic discretionary capability comprises using the automatic discretionary capability to override the user interface preference information with other user interface preference information.

3. The method of claim 1 wherein the automatic discretionary capability is used to confirm the user interface preference information and accept control of the user interface.

4. The method of claim 1 wherein using the automatic discretionary capability comprises weighting at least some of the user interface preference information.

5. The method of claim 4 wherein weighting at least some of the user interface preference information comprises providing weighting factors as a function of at least one predetermined factor.

6. The method of claim 5 wherein the at least one predetermined factor relates to at least one of:
proximity of the device to another object;
local loudness;
local brightness;
local temperature;
majority rules;
house rules; and
historical factors.

7. The method of claim 1 wherein providing the device with an automatic discretionary capability comprises providing the device with an automatic discretionary capability of determining whether to use, and to what extent to use, a plurality of wireless messages that each contain user interface preference information as was initially sourced by a corresponding plurality of end user platforms.

8. The method of claim 1 further comprising:
receiving a plurality of wireless messages that each contain user interface preference information as was initially sourced by a corresponding plurality of end user platforms.

9. The method of claim 8 wherein using the automatic discretionary capability comprises determining to what extent to use the user interface preference information to influence control of the user interface as a function, at least in part, of a majority-based view of the user interface preference information.

10. The method of claim 1 wherein the user interface preference information corresponds to a volume level of an audible annunciation mechanism and the device is a two-way communications device that uses the user interface preference information to control the volume level.

11. A method of claim 1 further comprising:
at a wireless transmission device having a user interface:
maintaining at the wireless transmission device a user interface profile that contains the user interface preference information;
wirelessly transmitting the user interface preference information to the device having the user interface.

12. An apparatus comprising:
a user interface;
a wireless receiver;
a memory operably coupled to the wireless receiver and having stored therein user interface preference information as was initially sourced by an end user platform and received at the wireless receiver;
a processor operably coupled to the memory and the user interface and being configured and arranged to:
provide an automatic discretionary capability of determining whether to use, and to what extent to use, the user interface preference information; and
use the discretionary capability to determine to what extent to use the user interface preference information to influence control of the user interface.

13. The apparatus of claim 12 wherein the processor comprises:
means for providing an automatic discretionary capability of determining whether to use, and to what extent to use, the user interface preference information;
means for using the discretionary capability to determine to what extent to use the user interface preference information to influence control of the user interface.

14. The apparatus of claim 12 wherein the processor uses the automatic discretionary capability to determine whether to use, and to what extent to use, a plurality of wireless messages that each contain user interface preference information as was initially sourced by a corresponding plurality of end user platforms.

15. The apparatus of claim 12 wherein the wireless receiver receives a plurality of wireless messages that each contain user interface preference information as was initially sourced by a corresponding plurality of end user platforms.

16. The apparatus of claim 12 wherein the processor uses the automatic discretionary capability to determine to what extent to use the user interface preference information to influence control of the user interface as a function, at least in part, of a majority-based view of the user interface preference information.

17. A method for use with a plurality of two-way communications devices having audible annunciation mechanisms comprising:
in response to a need to control the audible annunciation mechanisms:
selecting a desired volume level for the audible annunciation mechanisms;
transmitting an audible annunciation mechanism control signal to the plurality of two-way communications devices to indicate the desired volume level;
at the plurality of two-way communications devices:
receiving the audible annunciation mechanism control signal;
using the desired volume level to facilitate control of a local audible annunciation mechanism.

18. The method of claim 17 wherein the local audible annunciation mechanism has an automatic discretionary capability of determining whether to use, and to what extent to use, the audible annunciation mechanism control signal and uses the automatic discretionary capability to determine to what extent to use the audible annunciation mechanism control signal to influence control of the audible annunciation mechanism.

19. The method of claim 17 wherein the two-way communications device overrides the control signal.

20. The method of claim 17 further comprising:
transmitting an audible mechanism control signal to indicate a desired volume level for devices having a user interface.
